(19) United States
(12) Patent Application Publication
(10) Pub. No.: US 2026/0283746 A1
(43) Pub. Date: Sep. 24, 2026

(54) Electronic Dental Dispensing Device

(71) Applicant: KULZER GMBH, Hanau (DE)

(72) Inventors: Mario BEYER, Bad Homburg (DE); Shingo SATO, Tokyo (JP)

(73) Assignee: KULZER GMBH, Hanau (DE)

(21) Appl. No.: 19/490,048

(22) PCT Filed: Jun. 12, 2024
(86) PCT No.: PCT/EP2024/066204

§ 371 Date: Dec. 4, 2025

(30) Foreign Application Priority Data
Jun. 13, 2023 (DE) 10 2023 115 333.1

(51) Int. Cl. A61C 5/00

(52) U.S. Cl. CPC A61C 5/00

(57) ABSTRACT

Electronic dental dispensing devices is provided for applying and polymerizing dental compositions, wherein the devices comprise a housing with a handle having a connection geometry in the front housing region for receiving an application capsule with an outlet comprising the composition or for receiving an adapter for receiving an application capsule with an outlet comprising the composition. The devices further comprise: a reading unit in the front housing region for a contactless data exchange using electromagnetic induction or by means of electromagnetic radiation; a radiation source for polymerizing the applied composition; an electronic vibration unit in the housing; a manual or electronic pressing-out device in the housing for pressing the composition out of the outlet of the application capsule; an electric heat source; a data transmission module; a battery; and at least one control unit.

The invention relates to an electronic dental dispensing device for the application and preferably polymerization of dental compositions, comprising a housing with a handle part with a connection geometry in the front housing area for receiving an application capsule with an outlet comprising the composition or for receiving an adapter for receiving an application capsule with an outlet comprising the composition, with a reading unit for contactless data exchange by electromagnetic induction or by means of electromagnetic radiation in the front housing area, with a radiation source for polymerizing the applied composition, with an electronic vibration unit in the housing, with a manual or electronic squeezing device in the housing for squeezing the composition out of the outlet of the application capsule, and with an electrical heat source, optionally with a data transmission module, such as a radio module, with a rechargeable battery and at least one control unit and optionally a display and optionally with an operating unit, and with a charging and/or data connection.

According to WO2009/113843A1 and WO2016/154060A1, dispensing devices with a vibration unit for dispensing pastes are known from the prior art.

There is therefore a need to provide a dispensing device that opens up further applications in the dental field, is easier to use, and increases user acceptance. There is also a need for dispensing devices that allow users to concentrate on the application and/or modeling of a composition and receive force assistance for dispensing the composition. In addition, there is a need to be able to apply highly filled and therefore highly viscous composites from a dispensing device, which has not been possible to date due to the high viscosity.

The present invention was therefore based on the purpose of providing an improved dispensing device that enables further applications in the dental and/or pharmaceutical field and avoids the disadvantages of the prior art.

The purpose of the invention is solved by a dispensing device according to claim 1 and the use according to claim 13. Specific embodiments of the invention are disclosed in detail in the subclaims and in the description.

According to the invention, the purpose of the present invention is solved by a dispensing device comprising an electronic vibration unit and a radiation source or a vibration unit and a reading unit for contactless data exchange by electromagnetic induction, preferably the dispensing device comprises all three components.

The invention therefore relates to an electronic dental dispensing device, in particular for the application of a dental and/or pharmaceutical composition, comprising a housing with a handle part with a connection geometry in the front housing area for receiving an application capsule with an outlet, in particular comprising a composition, in particular an application capsule comprising a dental and/or pharmaceutical composition, or for receiving an adapter for receiving an application capsule with an outlet, in particular an application capsule comprising a composition, in particular with a reading unit for contactless data exchange by electromagnetic induction or by electromagnetic radiation in the front housing area, in particular by scanning with electromagnetic radiation, with a radiation source which is particularly suitable for polymerizing and/or curing the dental and/or pharmaceutical composition, with an electronic vibration unit, in particular in the front housing area, which connects to the connection geometry inside the housing or accommodates it, the vibration unit is preferably coupled to a vibration damper, in particular for vibration damping, which decouples the vibration unit from the housing, and with a manual or electronic squeezing device in the housing for squeezing the composition out of the outlet of the application capsule, and optionally with an electrical heat source, and optionally with a data transmission module, and with a rechargeable battery and at least one control unit and optionally a display and optionally with an operating unit, and with a charging and/or data connection.

The invention also relates to an electronic dental dispensing device, in particular for the application of a dental and/or pharmaceutical composition, comprising a housing with a handle part with a connection geometry in the front housing area for receiving an application capsule with an outlet, in particular an comprising an application capsule with a composition, in particular comprising a dental and/or pharmaceutical composition, or for receiving an adapter for receiving an application capsule with an outlet, in particular comprising a composition, with a reading unit for contactless data exchange by electromagnetic induction, and optionally with a radiation source, which is particularly suitable for the polymerization and/or hardening of the dental and/or pharmaceutical composition, with an electronic vibration unit, in particular in the front housing area, which connects to or accommodates the connection geometry inside the housing, the vibration unit is preferably coupled to a vibration damper which decouples the vibration unit from the housing, and with a manual or electronic squeezing device in the housing for squeezing the composition out of the outlet of the application capsule, and optionally with an electrical heat source, and optionally with a data transmission module, in particular a radio module, and with a rechargeable battery and at least one control unit and optionally a display and optionally with an operating unit, and with a charging and/or data connection.

In a particularly preferred alternative, the dispensing device has a reading unit for contactless data exchange by electromagnetic induction. This reading unit can be arranged at the front of the housing, in particular integrated into the connection geometry or arranged next to the connection geometry. This reading unit may preferably be an RFID reading unit, in particular an NFC reading unit. It is further preferred that the reading unit, in particular a reading unit with an antenna, receives or detects data for contactless data exchange by electronic induction and transmits this data to the control unit, in particular by means of an electrical connection. The reading unit preferably comprises at least one antenna as at least one receiver or at least one receiving coil and/or transmitter or at least one transmitting coil. Furthermore, it is preferable if the reading unit transmits a defined carrier signal or several defined carrier signals for contactless data exchange. The reading unit can preferably comprise a receiving unit and/or transmitting unit analogous to the data transmission module. Alternatively, the reading unit and the data transmission module can be designed as a joint module.

An NFC (Near Field Communication) reading unit has, in particular, two-way communication, preferably using one of the two methods of card emulation and/or peer-to-peer (P2).

Furthermore, it is preferred that the data transmission module of the dispensing device comprises, as a transmitting and/or receiving unit, an RFID transmitting and/or receiving unit and/or NFC transmitting and/or receiving unit (NFC: Near Field Communication), which in particular has two-way communication, preferably using one of the two methods card emulation and/or peer-to-peer (P2).

NFC can be used to exchange data with smartphones or other NFC-enabled devices, especially those in close proximity, preferably within a range of up to 10 cm. NFC uses RFID technology.

The RFID reader operates contactlessly due to magnetic or electromagnetic coupling between the RFID transponder and the RFID reader. The RFID transponder and the RFID reader usually communicate with each other via an interface, preferably via the Contactless Chip Card Interface (CCI). The selected range of the dispensing device can be adjusted between 1 cm and 10 m by setting the RFID frequencies of the RFID reader and the RFID transponder, with 1 cm to 30 cm being preferred. The field strength of the RFID reader can be determined by selecting either an active or passive concept. This allows passive and semi-passive transponders to have a significantly higher transmission power in order to generate the energy for their supply from the carrier signal of the RFID reading unit. A passive or semi-passive transponder obtains its operating voltage from the inductive or electromagnetic field, whereby the semi-passive transponders have a small rechargeable battery.

The reading unit according to the invention for contactless data exchange by electromagnetic induction, in particular the RFID reading unit, and/or the data transmission module, RFID transmitting and/or receiving unit, preferably generate a high-frequency electromagnetic field with a corresponding RFID frequency in order to read out the data from an RFID transponder in particular. An RFID transponder guided into the alternating field receives the carrier signal of the RFID reading unit. The RFID reading unit can serve as an energy source to charge the rechargeable battery of the passive and semi-passive RFID transponder. Furthermore, load modulation of the HF field of the reading unit can be carried out for signal transmission from the RFID transponder.

The RFID transponder, reading and/or transmitting unit and/or reading and/or transmitting device can be operated by means of “close coupling” with ranges of 0 to 1 cm and preferably a frequency range of 1 Hz to 30 MHz. Data transmission between the transponder and the reading and/or receiving unit or reading and/or receiving device of the system can be carried out by inductive or capacitive coupling. In this way, a high level of data transmission security can be guaranteed.

Alternatively, the RFID transponders, RFID reading and/or transmitting unit and/or RFID reading and/or transmitting device can be operated by means of “remote coupling,” whereby ranges of up to 1 m can be provided and operation takes place in particular at frequencies between 100 and 135 kHz, around 6.75 MHz, around 13.56 MHz, and/or 27.125 MHz. Data transmission is preferably carried out by means of inductive coupling.

According to a further alternative, the aforementioned RFID transponder, RFID reading and/or transmitting unit, RFID reading and/or transmitting device can be operated by means of “long range” with ranges of 1 m to 10 m. The typical frequency range is in the microwave range. It may also be preferable if the dispensing device comprises one or more of the aforementioned methods, including “close coupling,” “remote coupling,” and/or “long range.”

Furthermore, it may be preferable if the dispensing device, synonymous with dispensing apparatus, the reading unit and/or the application capsule, in particular each independently, comprise a chip, a memory unit and/or a look-up table, each of which have an electronic product code for unique assignment. Preferably, each application capsule is assigned a unique product code, in particular a product code such as a digital product code, preferably an electronic product code, which is linked to instructions for handling the composition. The instructions for handling preferably comprise instructions such as digital information for extruding the composition, liquefying the composition, reducing the viscosity of the composition for extruding, curing the composition and/or polymerizing the composition.

An electronic product code (EPC) enables products to be uniquely identified worldwide. For this purpose, it contains a number that is uniquely assigned to a manufacturer, in particular a manufacturer of a composition in an application capsule. A so-called Object Name Service (ONS) assigns the EPC serial number an internet address in the form of a URL that refers to an object description of the manufacturer in PML format. This means that information about tagged products and/or application capsules, in particular application capsules with a composition, can be accessed at any time via the Internet. The EPC was developed by the EPCglobal organization in the USA. The EPC is compatible with the numbering system of the international article number EAN.

It may be preferable if the dispensing device has a reading unit and/or a data transmission module with an EPC standard, which RFID transponders and/or NCF transponders have an EPC standard, in particular the application capsule, the application device, preferably the control unit, the look-up table and/or the aforementioned components, etc. Furthermore, it is preferable if the EPC standard is equipped with an EPC Gen 2 interface. It is further preferable if the header of the product code, in particular the EPC header, always comprises at least 8 bits or from 8 to 256 bits.

The charging and/or data connection according to the invention can support resonant charging, inductive charging and/or wired charging and/or resonant data exchange, inductive data exchange and/or wired data exchange.

The control unit of each of the dispensing devices according to the invention preferably comprises a memory with a database or look-up table, by means of which the dispensing device can assign the composition in the application capsule, in particular the product code, preferably the electronic product code. After assigning the composition, the dispensing device can recognize whether the composition is suitable for processing by means of vibration and/or heat, in particular for premixing, liquefying, reducing viscosity and/or premixing and liquefying. The database or look-up table can contain digital information on the type of composition, such as dental filling materials, such as dental cement, retraction paste, dental fissure material, acid-containing dental material, impression material, in particular comprising silicone, pharmaceutical composition, such as anesthetic, and/or digital information and digital instructions for operation and/or treatment, in particular processing of the composition, by the dispensing device. The memory of the at least one control unit of the dispensing device can thus contain the look-up table with digital instructions for controlling the dispensing device, in particular the vibration unit, the electrical heat source, at least one sensor, such as a temperature sensor, the reading unit, the data transmission module, the squeezing device and/or the radiation source by means of the dispensing device. The vibration unit is preferably an actuator, such as a linear actuator or a linear actuator.

In particular, the memory of the control unit and/or the lookup table may also contain digital instructions for controlling the reading unit. Alternatively or additionally, the memory and/or the lookup table may comprise digital instructions for the radiation source for the exposure time, the power of the radiation source, the emitted wavelength(s) of the radiation source, in particular for a composition.

Alternatively, the radio module of the dispensing device can transmit the data read by the reading unit for contactless data exchange, in particular from an RFID transponder, in particular NFC transponders of an application capsule, to a further radio module of a further computer, which has digital information and/or digital instructions for processing the composition and transmits these, in particular after recognition of the composition, to the dispensing device. Alternatively, the database or the lookup table can be updated with the information and/or instructions by means of the radio module. A radio module according to the invention preferably comprises a receiving unit and/or a transmitting unit, such as a WLAN module or bluetooth module for wireless data transfer. The radio module may preferably have at least one or more antennas, in particular at least one antenna in the receiving and/or transmitting unit.

The control unit of each of the dispensing devices according to the invention may preferably comprise a memory with a database or look-up table, by means of which the dispensing device can assign the composition in the application capsule.

According to a further preferred embodiment, the invention relates to an electronic dental dispensing device, in particular for the application of a dental and/or pharmaceutical composition, comprising a housing with a handle part with a connection geometry in the front housing area for receiving an application capsule with an outlet, in particular comprising a composition, in particular comprising a dental and/or pharmaceutical composition, or for receiving an adapter for receiving an application capsule with an outlet, in particular comprising a composition,
with a reading unit for contactless data exchange by electromagnetic induction or by means of electromagnetic radiation in the front housing area,
with a radiation source, which is particularly suitable for the polymerization and/or hardening of the dental and/or pharmaceutical composition,
with an electronic vibration unit in the front housing area, which is connected to the connection geometry inside the housing or accommodates it,
with a manual or electronic squeezing device in the housing for squeezing the composition out of the outlet of the application capsule,
with an electric heat source,
optionally with a data transmission module,
with a rechargeable battery and at least one control unit and optionally a display and optionally an operating unit, and
with a charging and/or data connection.

The dispensing device can optionally have an operating unit, since the operating unit can be located on another device due to the data transmission module, so that the dispensing device can be operated from another device by means of the data transmission module. Such another device can be a foot pedal or a mobile computer, such as a mobile phone, as an operating unit. The control unit is preferably part of a processor. The invention therefore relates to a dispensing device comprising at least one processor comprising the at least one control unit. The invention also relates to a dispensing device comprising a computer comprising at least one processor, which in particular comprises the at least one control unit.

The invention also relates to a dispensing device in which the reading unit, radiation source, vibration unit, squeezing device and/or heat source are electronically connected and/or interconnected with the control unit and a rechargeable battery. The connection is preferably made by means of electrical lines. In special embodiments, a data transmission module, display and/or operating unit are also electronically connected and/or interconnected with the reading unit, radiation source, vibration unit, squeezing device and/or heat source with the control unit and a rechargeable battery.

The control unit can preferably switch off the radiation source automatically to protect it from overheating.

The connection geometry may comprise a coupling for securing the application capsule, a magnetic coupling or a coupling with an insert into which the application capsule is inserted and then mechanically and/or magnetically coupled. In further alternatives, the connection geometry may comprise a Luer-Lock coupling.

An application capsule may comprise disposable packaging, primary packaging such as a PLT or Carpule®. An application capsule may also comprise a syringe housing, a single-component or multi-component cartridge. A static mixing element and/or a cannula can be attached to the outlet of the application capsule. Alternatively, the application capsule can be fixed to the connection geometry by means of an adapter.

In a further embodiment, the reading unit of the dispensing device is an RFID reading unit, in particular an NFC reading unit, or a scanner based on electromagnetic radiation, which is based in particular on scanning by means of electromagnetic radiation, preferably on scanning surfaces and the information contained thereon, such as barcodes. The electromagnetic radiation of the reading unit may comprise UV radiation (100 to 400 nm, preferably UV-A radiation: 400 to 315 nm, preferably no UV-B 315 to 280 nm and/or UV-C radiation from 280 to 100 nm), Vis radiation, from 401 nm, preferably from 401 to 830 nm, UV/Vis radiation and/or IR radiation, in particular from 780 nm to 1 millimeter. The reading unit may comprise an RFID and/or NFC reading unit and/or a scanner based on electromagnetic radiation. The scanner may alternatively or additionally be designed as an intraoral scanner. The scanner may alternatively or additionally comprise an infrared sensor. The infrared sensor can be used to detect IR spectra of the composition in a non-polymerized and/or partially polymerized as well as completely polymerized state. The infrared sensor is preferably used to detect IR spectra of an applied composition in order to determine the double bond conversion in the applied composition. Alternatively or additionally, the scanner can record black-and-white or color images as an intraoral scanner of the situation in a patient's mouth. The scanner can alternatively comprise a lidar sensor that can create a height profile in black and white and/or a height profile in color. The scanner may comprise an intraoral scanner, an infrared sensor for determining IR spectra, a lidar sensor for determining height profiles, distances and/or tooth cavities and/or the extrusion speed of a composition. The dispensing device according to the invention can preferably scan a tooth cavity by means of a scanner in order to determine the volume of the tooth cavity and preferably determine the dispensing quantity of the composition from the application capsule used on the basis of the determined volume. After determining the dispensing quantity, the dispensing device can preferably determine the determined dispensing quantity of the composition in the inserted application capsule and discharge it from the outlet of the application capsule by means of a squeezing device.

The electromagnetic radiation of the radiation source may comprise UV radiation (100 to 400 nm, preferably UV-A radiation: 400 to 315 nm, preferably no UV-B 315 to 280 nm and/or UV-C radiation from 280 to 100 nm), Vis radiation, from 401 nm, preferably from 401 to 830 nm, UV/Vis radiation and/or IR radiation, in particular from 780 nm to 1 millimeter. A wavelength range of 400 to 500 nm, preferably from 450 to 470 nm, is particularly preferred. The electromagnetic radiation source is preferably at least one LED (light-emitting diode), preferably with an optical power of 0 to 4000 mW/cm², in particular with +/−10%. Preferably with an optical power of 1000 to 3500 mW/cm². The radiation source may have a temperature sensor or a bimetal that protects the radiation source from overheating. The temperature sensor can transmit the temperature of the radiation source measured by the temperature sensor or information from the temperature sensor to the control unit, which has a reference table containing a temperature specification and an instruction for protection against overheating, and the control unit causes the radiation source to switch off.

According to a further alternative, it is preferable if the reading unit and/or the radiation source are arranged in the front housing area, in particular on the outside in the front housing area, preferably below the connection geometry or below the application capsule arranged in the connection geometry, and can be moved independently or as a module from the front housing area towards the front, in particular in the direction of the outlet of the application capsule. Furthermore, it is preferred that the radiation source can be moved electronically out of the front housing at the front and, optionally, the radiation angle of the radiation source can be adjusted electronically at an angle of 20° to 160° with respect to the longitudinal center axis of the dispensing device.

In a particularly preferred embodiment, the dispensing device comprises a vibration unit, in particular an electronic vibration unit, preferably comprising an electric motor coupled to at least one vibrating body, a balance wheel and/or other mechanical components suitable for generating and transmitting vibrations, wherein the vibration unit is preferably coupled to at least one vibration damper which decouples the vibration unit from the housing. A vibration damper may comprise a vibration damper made of an elastic material, in particular silicone and/or rubber. This measure prevents the transmission of vibrations to the housing and thus to the operator of the dispensing device. Without vibration dampers, undesirable transmission of the vibration to the housing and thus an unpleasant feeling in the operator's hand may occur. Furthermore, this measure allows a vibration unit with a stronger vibration to be used in the dispensing device, which enables improved premixing of the composition or activation of a composition.

With vibration dampers, the vibration unit can preferably have a control for setting the wavelength, period, and/or amplitude of the vibrations so that the vibration and, optionally, the duration of the vibration can be set, preferably automatically, for the respective composition. Preferably, the wavelength, period and/or amplitude of the vibrations of the vibration unit are controlled by the control unit. The information on the wavelength, period and/or amplitude and optionally the duration of the vibration can be stored in the memory of the control in a look-up table or an external database.

It is also preferred if the electronic vibration unit has an electric vibration motor which is coupled to the operating unit and optionally to the manual or electronic squeezing device.

According to a further embodiment, the at least one electrical heat source is an electrical resistance heater. It is further preferred that the electrical resistance heater is integrated into the vibration unit. It is particularly preferred that the inner or front surface of the vibration unit that comes into contact with the connection geometry, or the inner surface of the vibration unit into which the application capsule can be inserted, is lined with an electrical resistance heater. The heat source is preferably heatable and controllable in the temperature range from 10° C. to 100° C., preferably from 10° C. to 60° C., and more preferably from 21° C. to 50° C.

Alternatively, the connection geometry can be arranged in the front housing area, whereby the connection geometry is arranged within the vibration unit, in particular with an electrical heat source, so that an application capsule arranged on the connection geometry is arranged within the vibration unit. In this way, it is possible for the application capsule to be subjected to vibrations by means of the vibration unit and, optionally, to heat treatment by means of the electrical heat source arranged on the inner surface.

The vibration unit can preferably generate vibrations with frequencies of 1 Hz to 10 MHz, preferably of 3 Hz to 200 kHz (Hz: Hertz) or of 200 Hz to 3 MHz. In a particularly preferred alternative, the vibration can be from 50 Hz to 200 Hz. Alternatively, a vibration frequency range greater than or equal to 20 kHz to 5 MHz may also be preferred. Particularly preferred vibration frequency ranges are from 2 kHz to 100 kHz, and more preferably from 2 kHz to 10 kHz. According to a further alternative, a sound pressure level of 0.001 dB to 40 dB may be preferred, preferably from 0.01 dB to 10 dB. The vibration unit is particularly preferred for shaking and/or vibrating an application capsule inserted into the dispensing device.

Furthermore, it is preferred that the dispensing device has a module in which the reading unit and the radiation source are integrated, wherein the radiation source and the reading unit preferably have a common control unit for contactless data transfer by means of electromagnetic radiation. The module may comprise a reading unit which is operated with the same radiation source as the radiation source for polymerizing and/or curing the applied composition. A preferred radiation source is at least one LED whose light output is adjustable from 0 to 3000 mW/cm², in particular from 10 to 3000 mW/cm². Alternatively or additionally, at least one, preferably two to 20 LEDs, wherein the LEDs can be controlled individually or in groups, are operated in the reading and/or radiation source. Preferably, the LEDs can be controlled for both the reading and the radiation source by means of software for the respective function. The LEDs can have UV and/or Vis spectra. The LEDs for the radiation source preferably have a wavelength range of 400 nm to 500 nm, preferably from 450 to 470 nm. The LEDs of the reading and/or radiation source can also be controlled for a defined period of time. Preferred exposure times for polymerization are in the range of 5 s to 60 s, preferably from 20 s to 40 s, in particular in the wavelength range from 400 to 500 nm.

The invention also relates to a dispensing device comprising a charging connection for inductive charging, resonant charging and/or wired charging. The invention also relates to a data connection for resonant data exchange, inductive data exchange and/or wired data exchange.

For resonant and/or inductive charging and/or data exchange, the charging and/or data connection preferably comprises an electrical circuit having at least one capacitor and at least one coil, in particular for forming one or more resonant circuits between the at least one coil in the dispensing device and at least one coil in a charging station, in particular at least one capacitor and at least one coil in the charging station. Advantages of resonant charging are that several devices can be charged simultaneously, the devices can be placed imprecisely on the charging surface of the charging station, the efficiency of resonant charging is higher, and a greater proportion of the energy reaches the rechargeable battery during charging. A Qi-charger (standard) can be used for inductive charging. In a particularly preferred embodiment, an electronic dispensing device comprises a resonant charging and/or data connection comprising at least one coil and a capacitor. The invention also relates to a system comprising the dispensing device with a charging and/or data connection and a transmitter device comprising a charging and/or data connection.

The invention also relates to a dispensing device comprising a charging and/or data connection for resonant data exchange, inductive data exchange and/or wired data exchange. The charging and/or data connection may comprise a wired connection, such as in particular USB, preferably USB-B and/or USB-C connection or Lightning connection. A charging and data connection is preferred. The data exchange may take place with a database and/or a control unit comprising a memory and/or a look-up table comprising in particular the aforementioned information.

A data connection is preferably a broadband connection to a packet-oriented network, such as the Internet, which enables various services. The data connection can be implemented either wired or wireless via mobile phone-based access or by means of a wireless local loop.

The charging and/or data connection may comprise for inductive or resonant energy and/or data transmission from a transmitting device, in particular an external charging and/or data transmission device, to a receiving unit in the dispensing device and/or at least one receiving device, each with at least one receiving device which is designed as a receiving coil.

The transmitting device, in particular the external charging and/or data transmission device, comprises, in particular comprising a charging and/or data connection, at least one transmitting device with at least one transmitting device which is designed as a transmitting coil. The dispensing device comprising the receiving unit and the transmitting unit, and the external charging and/or data transfer device may preferably be designed as a system or be available as a kit.

It is further preferred that at least one first capacitor is connected in parallel to the receiving coil so that the receiving coil and the first capacitor form a parallel resonant circuit. Conductors for tapping the alternating voltage from the receiving coil are provided on the first capacitor, and a second capacitor is connected in series with the receiving coil so that the first and second capacitors form a capacitive voltage divider.

Furthermore, it is preferable if the first capacitor has the same capacity as the second capacitor. Furthermore, it is preferable if the at least one receiving coil in the dispensing device and/or, if applicable, the at least one transmitting coil in the transmitting device each have independent high-frequency strands. It may also be preferred if the at least one receiving coil and/or the at least one transmitting coil are each independently designed as plate coils.

Furthermore, it is preferred that the transmitting device, in particular the external charging and/or data transmission device, is designed to be supplied with mains voltage, wherein it has a rectifier and an inverter. Preferably comprising rectifiers and/or inverters. It is also preferred if, in the transmitting device and/or the transmitting unit, at least one transmitting coil forms an oscillating circuit with a further electronic component and has an electronic measuring device for measuring the current in the oscillating circuit. The electronic component may comprise a further capacitor.

The invention also relates to a kit or system comprising a dispensing device, in particular with a receiving unit, and a transmitting device, in particular a charging and data transmission device. The system can preferably determine the current in the resonant circuit or in the parallel resonant circuit by means of a measuring device in the dispensing device or a measuring device in the transmitting device when the transmitting device and the dispensing device are arranged in different relative positions. It is preferable if, when the highest level of the determined current of all arrangements is determined, information about the arrangement with the highest level of current is output. This information can be output in the dispensing device or the transmitting device via a loudspeaker as a so-called acknowledgment tone and/or visual signal. In this way, the positioning with the best transmission quality can be determined.

Furthermore, a dispensing device is preferred in which the manual squeezing device comprises at least one stamp, in particular a hydraulically and/or pneumatically driven stamp, or the electronic squeezing device comprises at least one stamp, in particular a mechanically, hydraulically and/or pneumatically driven stamp, and/or drive device, such as a shaft, in particular a rotor shaft, in particular a worm shaft, and a drive motor. A shaft is a rotatable or rotating machine element. The manual squeezing device preferably has, in addition to at least one stamp, at least one handle with which the stamp can be inserted into the application capsule arranged in the dispensing device and the composition can be conveyed from the outlet of the application capsule. If the respective squeezing device has a stamp and an inner stamp, fine adjustment of the delivery of a composition can be carried out and/or a post-flow of the composition following delivery can be prevented.

The dispensing device preferably has an electronic squeezing device or a manual squeezing device which allows the presetting of a defined dispensing quantity of a composition, in particular a composition from an application capsule. This can be achieved, on the one hand, by the stamp and/or a shaft being movable from a predefined starting position to a predefined squeezing position, in particular the shaft being movable by means of an electromechanical converter, in particular an electric motor, and, in particular, being reversibly movable from a predefined starting position to a predefined squeezing position.

In a further preferred embodiment, the stamp and/or the shaft can be moved from a predefined starting position into a predefined squeezing position and, in particular after application of a quantity of composition from an application capsule inserted in the dispensing device, subsequently into a predefined return position. Alternatively, the stamp and/or the shaft can spring back to a reset position by releasing a lock on the spring-mounted stamp and/or spring-mounted shaft. In further alternatives, an inner stamp may be provided in the stamp, which is movably arranged for setting the return position of the stamp and, in particular, is movable inside the stamp for setting the return position of the inner stamp, in particular can be pressed in or moved into the stamp. The return position can be fixed by means of a locking device for the stamp and/or the shaft. The pressing in or moving in of the inner stamp into the stamp allows the composition to expand into the released cavity in the stamp, thus preventing the composition from running out of the outlet of the application capsule. The reset position serves to prevent the composition from running out of the application capsule after extrusion.

The respective starting or squeezing position may depend on the selected application capsule and/or the degree of filling of the application capsule. The advantage of presetting the dispensing quantity is that the dispensing device can thus inform the user of the remaining quantity of composition in the application capsule. This allows the user to determine the future usability of the remaining quantity of composition in the application capsule, thus enabling improved planning. Alternatively, the dispensing quantity in the application capsule of the dispensing device can be determined by means of a sensor. Preferably, the dispensing device has at least one sensor for determining the dispensing quantity of a composition of an application capsule inserted into the dispensing device, comprising the composition. The sensor may comprise a flow measurement sensor. The flow measurement sensor may be based on an ultrasonic measurement and/or flow measurement according to the differential pressure method or other methods known to the skilled person for determining volume and/or mass flows.

The dispensing device of the invention can preferably determine and/or indicate to the user the volume and/or mass of the composition in the application capsule inserted into the dispensing device. The dispensing device can also have a weighing sensor. Alternatively or additionally, the dispensing device can have a sensor for measuring temperature, humidity and/or gas. In an alternative, the application capsule also has a sensor for measuring temperature, humidity and/or gas, in particular the type of gas and/or the amount of gas, and optionally a battery or accumulator and/or a signal transmitter, such as a signal transmitter for visual and/or acoustic signals. The visual and/or acoustic signals of the signal transmitter can, for example, provide information on correct or incorrect storage conditions with regard to temperature, UV/Vis light and/or humidity of a composition in the application capsule and/or whether the application capsule has been correctly inserted into the dispensing device and optionally locked in place. Furthermore, the signal transmitter can indicate a blocked outlet of the application capsule in order to prevent the discharge of a polymerized plug, for example into the patient's mouth or onto a substrate surface.

In a particularly preferred embodiment, the at least one stamp of the manual squeezing device or the at least one stamp and/or the at least one shaft of the electronic squeezing device can be transferred, in particular displaceably transferable, from
an initial position, in particular a predefined initial position, into at least one squeezing position, in particular a variable squeezing position, preferably into a predefined variable squeezing position,
   preferably wherein, in the starting position, the stamp of the dispensing device rests against at least one movable piston of an application capsule arranged in the dispensing device, in particular by means of a shaft and the drive motor,
   wherein the at least one movable piston of the application capsule closes a cavity thereof with a side wall and an opposite side wall for receiving a composition or a composition for application, wherein the cavity has an outlet on the side wall opposite the piston or in a region of the side wall of the cavity which adjoins the opposite side wall of the application capsule, in particular for the application of the composition from the application capsule, and/or
a pressing position, in particular a variable pressing position, preferably from a variable predefined pressing position, into a return position, in particular into a variable return position, preferably into a predefined variable return position, in particular by means of a shaft and the drive motor, and/or
i. at least one sensor, in particular a flow sensor, weighing sensor and/or an optical sensor, for determining the dispensed quantity of a composition, and/or
ii. and optionally at least one spring-mounted stamp and/or at least one spring-mounted drive device, such as a mounted shaft, can be moved into a reset position by releasing a lock of the dispensing device, in particular the squeezing device,
   and optionally wherein the stamp has an inner stamp which is displaceably arranged in the stamp, in particular the stamp and the inner stamp are arranged so as to be displaceable independently of one another relative to one another. In particular by means of at least one gear rack or two shafts and the drive motor. Alternatively, in addition to or instead of a shaft, at least one rack, in particular a rack drive, or a similar drive device known to those skilled in the art may be selected.

The inner stamp is preferably used to set a reset position in order to prevent follow-up movement or also to set an ejection position for fine dosing of a composition. A starting position may comprise a position of a newly opened application capsule or also a position of a broken application capsule from which the composition has already been removed and which has been reinserted into the dispensing device. An squeezing position comprises all positions for dispensing a composition from an application capsule inserted into the dispensing device. A reset position comprises positions for removing the application capsule from the dispensing device and/or positions which prevent the composition from running out of the outlet of an application capsule. Preferably, the stamp and the inner stamp are of equal length so that, in particular, the respective front and rear sides of the stamps can lie in a common plane. The inner stamp is preferably arranged so as to be displaceable along the longitudinal axis in the stamp.

Preferably, the piston and inner pistons are of equal length. The inner piston is preferably arranged so as to be displaceable along the longitudinal axis in the piston. The piston, inner pistons, stamp, and/or inner stamp are each cylindrical along the outer circumference and the inner surface for receiving the inner stamp or inner piston.

According to a further preferred embodiment, the stamp and optionally the inner stamp of the electronic squeezing device can be driven by means of one or more drive devices, such as shafts, by the at least one drive motor. in particular, the at least one drive motor is controlled by the control unit of the dispensing device, preferably each shaft is driven by a respective drive motor in order to move the stamp and/or the inner stamp independently of an initial position into an squeezing position or from an squeezing position into a reset position. Preferably, a composition is discharged from the application capsule inserted into the dispensing device and, optionally, the composition is prevented from continuing to flow by setting a reset position.

Furthermore, a preferred dispensing device, in particular the electronic squeezing device, may comprise i. at least one sensor, in particular a flow sensor, weighing sensor and/or an optical sensor, for determining the dispensing quantity of a composition, and/or
ii. the dispensing device (0) determines the dispensing quantity on the basis of a position of the at least one shaft and/or the at least one stamp and optionally the inner stamp and optionally on the basis of the application capsule inserted into the dispensing device and optionally the product code, NFC transponder or NFC chip of the application capsule. The optical sensor can, for example, measure the movement of the emerging composition by scanning the emerging composition.

Furthermore, the dispensing device of the invention can read information from information carriers provided in connection with compositions, such as information, in particular product codes, preferably digital and/or electronic product codes, which are transmitted by means of barcodes, in particular 2D or 3D barcodes, RFID, NFC, hologram or in images or corresponding encrypted information transmitted by means of the aforementioned information carriers, information about the compositions such as type of composition, volume, mass, shelf life, manufacturer's information, color, further product characteristics, processing instructions, authenticity verification, patient information such as information on allergens, etc. The aforementioned information may preferably serve as additional information for authenticity control of the application capsule and/or the composition. A hologram may be particularly preferred for providing information for authenticity control.

The invention also preferably relates to a dispensing device comprising at least one control unit, a memory with a database or a look-up table, by means of which the dispensing device can assign the composition in the application capsule and, optionally, the dispensing device comprises a data processing system comprising a processor, which is adapted to cause the reading unit for contactless data exchange to read the data of an RFID transponder, in particular an NFC transponder of an application capsule, and in particular to compare these data with the data in the database or reference table in the memory of the control unit with regard to the type of composition in the application capsule, wherein the database or the reference table comprise digital instructions and/or digital information for the operation, in particular for the processing of the composition in the application capsule, for the processor of the dispensing device. The digital instructions and/or digital information preferably comprise instructions and/or information for controlling the reading unit, the squeezing device and, optionally, for controlling the vibration unit, electrical heat source and/or radiation source.

Furthermore, the invention preferably relates to a dispensing device with a memory which has at least one control unit of the dispensing device with at least one look-up table with digital instructions for controlling the vibration unit, the squeezing device and/or the radiation source by the dispensing device.

The invention also relates to the use of a dispensing device for the application, in particular for non-therapeutic application, of compositions, in particular dental compositions, and for radiation-induced polymerization, in particular non-therapeutic radiation-induced polymerization, of the dental composition. Furthermore, the invention relates to the use, in particular the non-therapeutic application, and/or mixing and/or heating of thixotropic compositions or activatable compositions. Compositions in the application capsule may comprise compositions such as dental polymerizable compositions, retraction paste, polymerizable one-or two-component compositions, dental cements, dental composites, fissure sealants, primers, adhesive dental compositions, ceramic sanitary compositions, activatable compositions comprising micelles and/or capsules which can be destroyed or dissolved by vibration in a matrix of a composition, dental retraction pastes, pharmaceutical formulations, such as anesthetics, such as local anesthetics, wound dressings, tooth bleaching gels and/or polymerizable or nourishing nail and/or hoof gels. Preferred compositions may comprise gels and pastes as well as gels and pastes consisting of destructible or dissolvable capsules. The application capsule can be fixed in the dispensing device by means of any locking device known to the skilled person, such as by insertion into a groove, bayonet lock, Luer lock, plugging and/or turning and/or sliding and snapping into an undercut, etc.

The invention also relates to an application capsule, in particular as a single-component or multi-component capsule, with an NFC transponder or NFC chip and optionally a dental and/or pharmaceutical composition. The NFC transponder or NFC chip can be recognized and read by a reading unit comprising an NFC reader or NFC reading unit. The application capsule may comprise single-component or multi-component capsules, in particular single-component or two-component capsules. The application capsule may also comprise a static mixer or a connection for receiving a static mixer. The subject matter of the invention may therefore also be a kit comprising an application capsule with an NFC transponder, a dental and/or pharmaceutical composition and optionally comprising a static mixer or with a connection for receiving a static mixer and optionally comprising a static mixer.

The invention also relates to an application capsule with a cavity with at least one side wall, at least one piston closing the cavity on one side, and a side wall opposite the at least one piston, whereby the cavity is formed. An outlet for dispensing or application is arranged on the opposite side wall or in an area of the side wall adjacent to the opposite side wall. In particular, the outlet serves to dispense a composition introduced into the cavity, preferably the outlet has a connection geometry for connection to an application needle, optionally with an inverted connection geometry. Preferably, the piston of the application capsule can have an inner piston which is arranged so as to be displaceable along the longitudinal axis of the piston, in particular the piston and the inner piston are cylindrical. Alternatively, the piston and, optionally, the inner piston may each have an external thread, wherein the side wall of the cavity and the inner cavity in which the inner piston is arranged in the piston each have a corresponding internal thread. The pistons close the cavity. The application capsule is airtight and/or moisture-proof ex works. Such pistons can then preferably be transferred by at least one drive device, such as a shaft of the squeezing device, into the cavity of the application capsule, in particular to discharge the composition.

The inner piston is used in particular to set a return position, in particular to prevent the composition from running out of the outlet, or for fine adjustment of the discharge in the squeezing position.

The invention is explained in more detail with reference to the figures, without limiting the invention to these embodiments. The figures show:

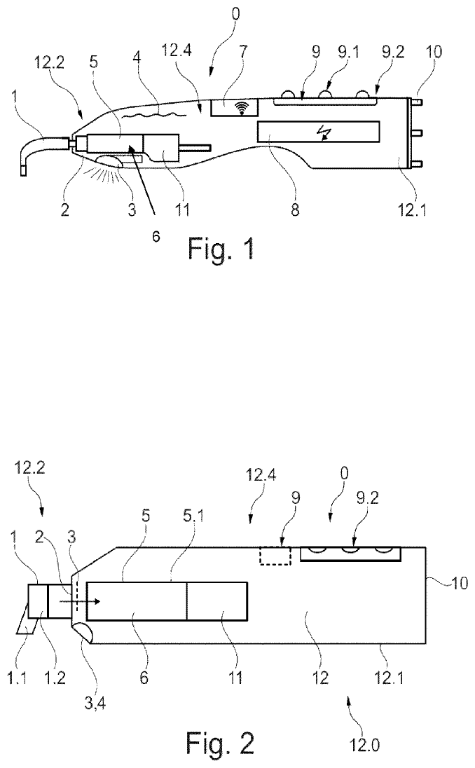

FIG. 1: Dispensing device 0 comprising reading unit 3, radiation source 4, electrical heat source 6 and electronic vibration unit 5.

FIG. 2: Dispensing device 0 with reading unit 3 in the front housing area 12.2 in the area of the connection geometry 2 and/or as a module together with the radiation source 4.

FIGS. 1 and 2 show a dispensing device 0 with housing 12 with front housing area 12.2 and rear housing area 12.1 and with inserted application capsule 1, in particular primary packaging or single dose or PLT. The application capsule has an outlet 1.1. The application capsule preferably contains a dental and/or pharmaceutical composition. Furthermore, the connection geometry 2 for receiving and fixing the application capsule 1 in the front part of the housing 12.2 is shown. FIG. 2 shows an adapter 1.2 for receiving different application capsules 1 in the dispensing device 0. The reading unit 3 can be arranged below the connection geometry on the outside of the housing as shown in FIG. 1, or, as shown in FIG. 2, as a module together with the radiation source in the front housing area 12.2. In a further alternative, the reading unit 3 can be arranged in the inner front housing 12.2 as a reading unit for contactless data exchange by electronic induction, preferably as a reading unit for NFC transponders or NFC chips. In the alternative in which the reading unit analyzes data by means of electromagnetic radiation, in particular the reading unit is a scanner, barcodes or IDs can be scanned. FIGS. 1 and 2 also show an electronic heat source 6 and the squeezing device 11. Furthermore, the dispensing device 0 has a charging and/or data connection 10 and at least one rechargeable battery 8. The rechargeable batteries, also known as secondary batteries or secondary cells, such as lithium-ion batteries, nickel-hydride batteries, sodium/nickel chloride, nickel-iron batteries, etc., are suitable for use as rechargeable batteries.

The radiation source 4 can be arranged at the front of the housing. The vibration unit 5 preferably comprises an electric motor and is arranged behind the connection geometry 2. Through the vibration unit, the squeezing device 11 can, for example, introduce a stamp into the application capsule in order to extract a composition from the outlet 1.1 of the capsule. The squeezing device comprises an actuator. The vibration unit of FIG. 2 is attached to the inside of the housing with vibration dampers 5.1. The vibration dampers reduce or prevent the transmission of vibrations to the housing.

The dispensing device 0 of FIGS. 1 and 2 has a data transmission module 7, such as a radio module, WLAN module, or Bluetooth module. The dispensing device 0 is controlled by at least one control unit 9, which comprises a memory with look-up table(s) containing information and data for controlling the dispensing device and, in particular, each independently of the reading unit 3, radiation source 4, squeezing device, heat source 6, control unit, display, data transmission module and/or charging and/or data connection. Furthermore, the dispensing device comprises a control unit 9, a display 9.1 and an operating unit 9.2. The display can be part of the operating unit 9.2. The operating unit 9.1 may have operating buttons. The housing of the dispensing device 0 has a handle part 12.1, a front housing area or front part of the housing 12.2, a rear housing area or rear part of the housing 12.3 and a middle housing area or middle part of the housing 12.4. The reading unit 3 can be based on NFC technology, which is an international transmission standard based on RFID technology for the contactless exchange of data via electromagnetic induction using loosely coupled coils over short distances of a few centimeters. The data transfer rate is limited to 424 kbit/s. The frequency is 13.56 MHz. Unlike RFID technology, NFC is a coupling method in which two systems communicate with each other and exchange data.

### Reference

0 Dispensing device
1 Application capsule, in particular primary packaging, such as disposable doses or PLT, optionally with NFC transponder or NFC chip and/or barcode, preferably application capsule comprising composition, in particular dental and/or pharmaceutical composition
1.1 Outlet of the application capsule
1.2 Adapter for receiving an application capsule
2 Connection geometry
3 Reading unit for contactless data exchange by electromagnetic induction or by scanning with electromagnetic radiation, in particular scanner or electronic reading unit, such as RFID reading unit, in particular reading unit with at least one antenna
4 Radiation source
5 Vibration unit
5.1 Vibration damper
6 Heat source
7 Data transmission module (radio module, in particular comprising receiving unit and transmitting unit)
8 Rechargeable battery
9 Control unit
9.1 Display
9.2 Operating unit
10 Charging and/or data connection
11 Squeezing device
12 Housing
12.1 Handle part
12.2 Front housing area or front part of the housing
12.3 Rear housing area or rear part of the housing
12.4 Middle housing area or middle part of the housing

1. Electronic dental dispensing device (0), for the application of a dental and/or pharmaceutical composition, comprising a housing (12) with a handle part (12.1),
with a connection geometry (2) in the front housing area (12.2) for receiving an application capsule (1) with an outlet (1.1), in particular an application capsule comprising a composition, or for receiving an adapter (1.2) for receiving an application capsule (1) with outlet (1.1) comprising a compound,
with a NFC-reading unit (3) for contactless data exchange via electromagnetic induction or a scanner based on electromagnetic radiation in the front housing area (12.2),
with a radiation source (4) that is suitable for polymerization and/or curing of the dental and/or pharmaceutical composition,
with an electronic vibration unit (5) in the front housing area (12.2), which connects to the connection geometry (2) inside the housing or accommodates the latter,
with a manual or electronic squeezing device (11) in the housing (12), in particular for pressing the composition out of the outlet (1.1) of the application capsule (1),
with an electric heat source (6),
optionally with a data transmission module (7),
with a rechargeable battery (8) and at least one control unit (9) and optionally a display (9.1) and
with an operating unit (9.2), and
with a charging and and/or data connection (10).

2. (canceled)

3. Dispensing device (0) according to claim 1, wherein the vibration unit (5) is coupled to at least one vibration damper (5.1) which decouples the vibration unit (5) from the housing (12).

4. Dispensing device (0) according to claim 1, wherein the electrical heat source (6) is an electrical resistance heater.

5. Dispensing device (0) according to claim 1, wherein the electrical heat source (6) is integrated in the electronic vibration unit (5).

6. Dispensing device (0) according to claim 1, wherein the reading unit (3) and the radiation source (4) are integrated in a module, wherein preferably the radiation source (4) and the reading unit (3) have a common control unit for contactless data transfer by means of electromagnetic radiation.

7. Dispensing device (0) according to claim 1, wherein the charging connection (10) is a charging connection for resonant charging, inductive charging and/or wired charging and/or the data connection is a data connection for resonant data exchange, inductive data exchange and/or wired data exchange.

8. Dispensing device (0) according to claim 7, wherein the charging and/or data connection for resonant and/or inductive charging and/or data exchange comprises an electrical circuit having at least one capacitor and at least one coil.

9. Dispensing device (0) according to claim 3, wherein the at least one vibration damper (5.1) is made of an elastic material, in particular of silicone and/or rubber.

10. Dispensing device (0) according to claim 1, wherein the manual squeezing device (11) comprises at least one stamp or the electronic squeezing device (11) comprises at least one stamp and/or at least one drive unit, in particular at least one shaft and at least one drive motor.

11. Dispensing device (0) according to claim 10, wherein the at least one stamp of the manual squeezing device (11) or the at least one stamp of the electronic squeezing device (11) and/or the at least one shaft of the electronic squeezing device (11) is transferable from
an initial position, in particular a predefined initial position, into at least one squeezing position, in particular a variable squeezing position, in particular wherein, in the initial position, the stamp of the dispensing device rests against at least one movable piston of an application capsule arranged in the dispensing device (0), wherein the at least one movable piston closes a cavity with a side wall and an opposite side wall for receiving a composition or a composition for application, wherein the cavity has an outlet, in particular for the application of the composition, on the side wall opposite the piston or in a region of the side wall of the cavity which adjoins the opposite side wall, and/or
from an squeezing position, in particular a variable squeezing position, preferably from a variable predefined squeezing position, into a return position, in particular into a variable return position, preferably into a predefined variable return position, and/or at least one spring-mounted stamp and/or at least one spring-mounted shaft is moveable into a reset position by releasing a lock, and optionally,
wherein the stamp has an inner stamp which is arranged in a displaceable manner in the stamp, in particular the stamp and the inner stamp are arranged in a displaceable manner relative to one another independently of one another.

12. Dispensing device (0) according to claim 11, wherein the stamp and optionally the inner stamp of the electronic squeezing device (11) are driven by means of one or more shafts by the at least one drive motor, in particular, the at least one drive motor is controlled by the control unit of the dispensing device (0) in order to move the stamp and/or the inner stamp from an initial position into an squeezing position or from an squeezing position into a reset position.

13. Dispensing device (0) according to claim 10, wherein the dispensing device (0), in particular the electronic squeezing device (11),
i. has at least one sensor, in particular a flow sensor, weighing sensor and/or an optical sensor, for determining the dispensing quantity of a composition, and/or
ii. the dispensing device (0) determines the dispensing quantity on the basis of a position of the at least one shaft and/or the at least one stamp and optionally the inner stamp and optionally on the basis of the application capsule inserted into the dispensing device and optionally the product code, NFC transponder or NFC chip of the application capsule.

14. Dispensing device according to claim 1, wherein the electronic vibration unit (5) has an electric vibration motor which is coupled to the operating unit (9.2) and optionally to the manual or electronic squeezing device (11).

15. Dispensing device (0) according to claim 1, wherein the reading unit (3) and/or the radiation source (4) are arranged in the front housing area (12.2) and are moveable forward each independently or as a module from the front housing area.

16. Dispensing device (0) according to claim 1, wherein
the control unit comprises a memory with a database or a look-up table by means of which the dispensing device is assignable to the composition in the application capsule and, optionally
the dispensing device has a data processing system comprising a processor which is adapted to cause the reading unit for contactless data exchange to read the data of an RFID transponder, in particular an NFC transponder, of an application capsule, and in particular to compare these data with the data in the database or look-up table in the memory of the control unit to determine the type of composition in the application capsule, wherein the database or the lookup table has digital instructions and/or digital information for operation, in particular for processing the composition in the application capsule, for the processor of the dispensing device.

17. Dispensing device (0) according to claim 16, wherein the memory of the at least one control unit of the dispensing device has the look-up table with digital instructions for controlling the vibration unit, the squeezing device, the reading unit, the heat source and/or the radiation source by the dispensing device.

18. System comprising a dispensing device (0) according to claim 1, in particular with a receiving device and with a transmitting device, in particular with a charging and data transmission device.

19. Use of a dispensing device (0) according to claim 1, for the application of dental compositions and radiation-induced polymerization of the dental composition.

20. Application capsule (1), in particular for use in a dispensing device according to claim 1 or in a system according to claim 18, wherein the application capsule has a NFC transponder or NFC chip.

21. Application capsule (1) according to claim 19, wherein it has a cavity with at least one side wall, at least one piston, in particular a piston and an inner piston, closing the cavity on one side, and a side wall opposite the at least one piston, whereby the cavity is formed, wherein an outlet for dispensing or application is arranged on the opposite side wall or in an area of the side wall adjacent to the opposite side wall, in particular for dispensing a composition introduced into the cavity, preferably the outlet has a connection geometry.
